(19) United States
(12) Patent Application Publication
(10) Pub. No.: US 2019/0193158 A1
(43) Pub. Date: Jun. 27, 2019

(54) ALUMINUM ALLOY PRODUCTS, AND METHODS OF MAKING THE SAME

(71) Applicant: ARCONIC INC., Pittsburgh, PA (US)

(72) Inventors: Deborah M. Wilhelmy, Greensburg, PA (US); Lynnette M. Karabin, Ruffs Dale, PA (US); Cagatay Yanar, Pittsburgh, PA (US); John Siemon, Cheswick, PA (US); Raymond J. Kilmer, Pittsburgh, PA (US); David W. Heard, Pittsburgh, PA (US); Gen Satoh, Murrysville, PA (US)

(21) Appl. No.: 16/288,478

(22) Filed: Feb. 28, 2019

Related U.S. Application Data
(63) Continuation of application No. PCT/US2017/050513, filed on Sep. 7, 2017.
(60) Provisional application No. 62/385,840, filed on Sep. 9, 2016.

(51) Int. Cl. B22F 3/105; B33Y 10/00; B33Y 30/00; B33Y 70/00

(52) U.S. Cl. CPC B22F 3/1055; B33Y 10/00; B22F 2302/25; B33Y 70/00; B22F 2003/1056; B33Y 30/00

(57) ABSTRACT

The present disclosure relates to new metal powders for use in additive manufacturing, and aluminum alloy products made from such metal powders via additive manufacturing. The composition(s) and/or physical properties of the metal powders may be tailored. In turn, additive manufacturing may be used to produce a tailored aluminum alloy product.

### CROSS-REFERENCE TO RELATED APPLICATION

This application is a continuation of International Patent Application No. PCT/US2017/050513, filed Sep. 7, 2017, which claims priority to U.S. Patent Application No. 62/385,840, filed Sep. 9, 2016, each of which is incorporated herein by reference in its entirety.

### BACKGROUND

Aluminum alloy products are generally produced via either shape casting or wrought processes. Shape casting generally involves casting a molten aluminum alloy into its final form, such as via pressure-die, permanent mold, green- and dry-sand, investment, and plaster casting. Wrought products are generally produced by casting a molten aluminum alloy into ingot or billet. The ingot or billet is generally further hot worked, sometimes with cold work, to produce its final form.

### SUMMARY OF THE INVENTION

Broadly, the present disclosure relates to metal powders and wires for use in additive manufacturing, and aluminum alloy products made from such metal powders and wires via additive manufacturing. The composition(s) and/or physical properties of the metal powders and wires may be tailored. In turn, additive manufacturing may be used to produce a tailored aluminum alloy product.

### BRIEF DESCRIPTION OF THE DRAWINGS

FIG. 1 is a schematic, cross-sectional view of an additively manufactured product (100) having a generally homogenous microstructure.

FIGS. 2a-2d are schematic, cross-sectional views of an additively manufactured product produced from a single metal powder and having a first region (200) of aluminum or an aluminum alloy and a second region (300) of an multiple metal phase, with FIGS. 2b-2d being deformed relative to the original additively manufactured product illustrated in FIG. 2a.

FIGS. 3a-3f are schematic, cross-sectional views of additively manufactured products having a first region (400) and a second region (500) different than the first region, where the first region is produced via a first metal powder and the second region is produced via a second metal powder, different than the first metal powder.

FIG. 4 is a flow chart illustrating some potential processing operations that may be completed relative to an additively manufactured aluminum alloy product. Although the dissolving (20), working (30), and precipitating (40) steps are illustrated as being in series, the steps may be completed in any applicable order.

FIG. 5a is a schematic view of one embodiment of using electron beam additive manufacturing to produce an aluminum alloy body.

FIG. 5b illustrates one embodiment of a wire useful with the electron beam embodiment of FIG. 5a, the wire having an outer tube portion and a volume of particles contained within the outer tube portion.

FIGS. 5c-5f illustrates embodiments of wires useful with the electron beam embodiment of FIG. 5a, the wires having an elongate outer tube portion and at least one second elongate inner tube portion. FIGS. 5c and 5e are schematic side views of the wires, and FIGS. 5d and 5f are top-down schematic views of the wires of FIGS. 5c and 5e, respectively.

FIG. 5g illustrates one embodiment of a wire useful with the electron beam embodiment of FIG. 5a, the wire having at least first and second fibers, wherein the first and second fibers are of different compositions.

FIG. 6a is a schematic view of one embodiment of a powder bed additive manufacturing system using an adhesive head.

FIG. 6b is a schematic view of another embodiment of a powder bed additive manufacturing system using a laser.

FIG. 6c is a schematic view of another embodiment of a powder bed additive manufacturing system using multiple powder feed supplies and a laser.

FIG. 7 is a schematic view of another embodiment of a powder bed additive manufacturing system using multiple powder feed supplies to produce a tailored metal powder blend.

### DETAILED DESCRIPTION

As noted above, the present disclosure relates to metal powders and wires for use in additive manufacturing, and aluminum alloy products made from such metal powders and wires via additive manufacturing. The composition(s) and/or physical properties of the metal powders and wires may be tailored. In turn, additive manufacturing may be used to produce a tailored aluminum alloy product.

The new aluminum alloy products are generally produced via a method that facilitates selective heating to temperatures above the liquidus temperature of the particular aluminum alloy product to be formed, thereby forming a molten pool followed by rapid solidification of the molten pool. The rapid solidification facilitates maintaining various alloying elements in solid solution with aluminum. In one embodiment, the new aluminum alloy products are produced via additive manufacturing techniques. Additive manufacturing techniques facilitate the selective heating of powders above the liquidus temperature of the particular aluminum alloy, thereby forming a molten pool followed by rapid solidification of the molten pool

As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. The aluminum alloy products described herein may be manufactured via any appropriate additive manufacturing technique described in this ASTM standard, such as binder jetting, directed energy deposition, material extrusion, material jetting, powder bed fusion, or sheet lamination, among others. In one embodiment, an additive manufacturing process includes depositing successive layers of one or more powders and then selectively melting and/or sintering the powders to create, layer-by-layer, an aluminum alloy product. In one embodiment, an additive manufacturing processes uses one or more of Selective Laser Sintering (SLS), Selective Laser Melting (SLM), and Electron Beam Melting (EBM), among others. In one embodiment, an additive manufacturing process uses an EOSINT M 280 Direct Metal Laser Sintering (DMLS) additive manufacturing system, or comparable system, available from EOS GmbH (Robert-Stirling-Ring 1, 82152 Krailling/Munich, Germany).

In one embodiment, a method comprises (a) dispersing a powder in a bed, (b) selectively heating a portion of the powder (e.g., via a laser) to a temperature above the liquidus temperature of the particular aluminum alloy product to be formed, (c) forming a molten pool and (d) cooling the molten pool at a cooling rate of at least 1000° C. per second. In one embodiment, the cooling rate is at least 10,000° C. per second. In another embodiment, the cooling rate is at least 100,000° C. per second. In another embodiment, the cooling rate is at least 1,000,000° C. per second. Steps (a)-(d) may be repeated as necessary until the aluminum alloy product is completed.

As used herein, “metal powder” means a material comprising a plurality of metal particles, optionally with some non-metal particles. The metal particles of the metal powder may be all the same type of metal particles, or may be a blend of metal particles, optionally with non-metal particles, as described below. The metal particles of the metal powder may have pre-selected physical properties and/or pre-selected composition(s), thereby facilitating production of tailored aluminum alloy products. The metal powders may be used in a metal powder bed to produce a tailored aluminum alloy product via additive manufacturing. Similarly, any non-metal particles of the metal powder may have pre-selected physical properties and/or pre-selected composition(s), thereby facilitating production of tailored aluminum alloy products. The non-metal powders may be used in a metal powder bed to produce a tailored aluminum alloy product via additive manufacturing

As used herein, “metal particle” means a particle comprising at least one metal. The metal particles may be one-metal particles, multiple metal particles, and metal-non-metal (M-NM) particles, as described below. The metal particles may be produced, for example, via gas atomization.

As used herein, a “particle” means a minute fragment of matter having a size suitable for use in the powder of the powder bed (e.g., a size of from 5 microns to 100 microns). Particles may be produced, for example, via gas atomization.

For purposes of the present patent application, a “metal” is one of the following elements: aluminum (Al), silicon (Si), lithium (Li), any useful element of the alkaline earth metals, any useful element of the transition metals, any useful element of the post-transition metals, and any useful element of the rare earth elements.

As used herein, useful elements of the alkaline earth metals are beryllium (Be), magnesium (Mg), calcium (Ca), and strontium (Sr).

As used herein, useful elements of the transition metals are any of the metals shown in Table 1, below.

TABLE 1
Transition Metals

| | Group | | | | | | | | |
|---|---|---|---|---|---|---|---|---|---|
| | 4 | 5 | 6 | 7 | 8 | 9 | 10 | 11 | 12 |
| Period 4 | Ti | V | Cr | Mn | Fe | Co | Ni | Cu | Zn |
| Period 5 | Zr | Nb | Mo | | Ru | Rh | Pd | Ag | |
| Period 6 | Hf | Ta | W | Re | | | Pt | Au | |

As used herein, useful elements of the post-transition metals are any of the metals shown in Table 2, below.

TABLE 2
Post-Transition Metals

| | Group | | |
|---|---|---|---|
| | 13 | 14 | 15 |
| Period 4 | Ga | Ge | |
| Period 5 | In | Sn | |
| Period 6 | | Pb | Bi |

As used herein, useful elements of the rare earth elements are scandium, yttrium and any of the fifteen lanthanides elements. The lanthanides are the fifteen metallic chemical elements with atomic numbers 57 through 71, from lanthanum through lutetium.

As used herein non-metal particles are particles essentially free of metals. As used herein “essentially free of metals” means that the particles do not include any metals, except as an impurity. Non-metal particles include, for example, boron nitride (BN) and boron carbine (BC) particles, carbon-based polymer particles (e.g., short or long chained hydrocarbons (branched or unbranched)), carbon nanotube particles, and graphene particles, among others. The non-metal materials may also be in non-particulate form to assist in production or finalization of the aluminum alloy product.

In one embodiment, at least some of the metal particles of the metal powder consists essentially of a single metal (“one-metal particles”). The one-metal particles may consist essentially of any one metal useful in producing an aluminum alloy, such as any of the metals defined above. In one embodiment, a one-metal particle consists essentially of aluminum. In one embodiment, a one-metal particle consists essentially of copper. In one embodiment, a one-metal particle consists essentially of manganese. In one embodiment, a one-metal particle consists essentially of silicon. In one embodiment, a one-metal particle consists essentially of magnesium. In one embodiment, a one-metal particle consists essentially of zinc. In one embodiment, a one-metal particle consists essentially of iron. In one embodiment, a one-metal particle consists essentially of titanium. In one embodiment, a one-metal particle consists essentially of zirconium. In one embodiment, a one-metal particle consists essentially of chromium. In one embodiment, a one-metal particle consists essentially of nickel. In one embodiment, a one-metal particle consists essentially of tin. In one embodiment, a one-metal particle consists essentially of silver. In one embodiment, a one-metal particle consists essentially of vanadium. In one embodiment, a one-metal particle consists essentially of a rare earth element.

In another embodiment, at least some of the metal particles of the metal powder include multiple metals (“multiple-metal particles”). For instance, a multiple-metal particle may comprise two or more of any of the metals listed in the definition of metals, above. In one embodiment, a multiple-metal particle consists of an aluminum alloy, such as any of the 1xxx, 2xxx, 3xxx, 4xxx, 5xxx, 6xxx, 7xxx, and 8xxx aluminum alloys, as defined by the Aluminum Association document “International Alloy Designations and Chemical Composition Limits for Wrought Aluminum and Wrought Aluminum Alloys” (2009) (a.k.a., the “Teal Sheets”), incorporated herein by reference in its entirety. In another embodiment, a multiple-metal particle consists of a casting aluminum alloy or ingot alloy, such as any of the 1xx, 2xx, 3xx, 4xx, 5xx, 7xx, 8xx and 9xx aluminum casting and ingot alloys, as defined by the Aluminum Association document “Designations and Chemical Composition Limits for Aluminum Alloys in the Form of Castings and Ingot” (2009) (a.k.a., “the Pink Sheets”), incorporated herein by reference in its entirety.

In one embodiment, a metal particle consists of a composition falling within the scope of a 1xxx aluminum alloy. As used herein, a “1xxx aluminum alloy” is an aluminum alloy comprising at least 99.00 wt. % Al, as defined by the Teal Sheets, optionally comprising tolerable levels of oxygen (e.g., from about 0.01 to 0.20 wt. % O) therein due to normal additive manufacturing processes. The “1xxx aluminum alloy” compositions include the 1xx alloy compositions of the Pink Sheets. A 1xxx aluminum alloy includes pure aluminum products (e.g., 99.99% Al products). A metal particle of a 1xxx aluminum alloy may be a one-metal particle (for pure aluminum products), or a metal particle of a 1xxx aluminum alloy may be a multiple-metal particle (for non-pure 1xxx aluminum alloy products). As used herein, the term “1xxx aluminum alloy” only refers to the composition and not any associated processing, i.e., as used herein a 1xxx aluminum alloy product does not need to be a wrought product to be considered a 1xxx aluminum alloy composition/product described herein,

In one embodiment, a multiple-metal particle consists of a composition falling within the scope of a 2xxx aluminum alloy, as defined in the Teal Sheets, optionally comprising tolerable levels of oxygen (e.g., from about 0.01 to 0.20 wt. % O) therein due to normal additive manufacturing processes. A 2xxx aluminum alloy is an aluminum alloy comprising copper (Cu) as the predominate alloying ingredient, except for aluminum. The 2xxx aluminum alloy compositions include the 2xx alloy compositions of the Pink Sheets. Also, as used herein, the term “2xxx aluminum alloy” only refers to the composition and not any associated processing, i.e., as used herein a 2xxx aluminum alloy product does not need to be a wrought product to be considered a 2xxx aluminum alloy composition/product described herein,

In one embodiment, a multiple-metal particle consists of a composition falling within the scope of a 3xxx aluminum alloy, as defined in the Teal Sheets, optionally comprising tolerable levels of oxygen (e.g., from about 0.01 to 0.20 wt. % O) therein due to normal additive manufacturing processes. A 3xxx aluminum alloy is an aluminum alloy comprising manganese (Mn) as the predominate alloying ingredient, except for aluminum. Also, as used herein, the term “3xxx aluminum alloy” only refers to the composition and not any associated processing, i.e., as used herein a 3xxx aluminum alloy product does not need to be a wrought product to be considered a 3xxx aluminum alloy composition/product described herein,

In one embodiment, a multiple-metal particle consists of a composition falling within the scope of a 4xxx aluminum alloy, as defined in the Teal Sheets, optionally comprising tolerable levels of oxygen (e.g., from about 0.01 to 0.20 wt. % O) therein due to normal additive manufacturing processes. A 4xxx aluminum alloy is an aluminum alloy comprising silicon (Si) as the predominate alloying ingredient, except for aluminum. The 4xxx aluminum alloy compositions include the 3xx alloy compositions and the 4xx alloy compositions of the Pink Sheets. Also, as used herein, the term “4xxx aluminum alloy” only refers to the composition and not any associated processing, i.e., as used herein a 4xxx aluminum alloy product does not need to be a wrought product to be considered a 4xxx aluminum alloy composition/product described herein,

In one embodiment, a multiple-metal particle consists of a composition consisting with a 5xxx aluminum alloy, as defined in the Teal Sheets, optionally comprising tolerable levels of oxygen (e.g., from about 0.01 to 0.20 wt. % O) therein due to normal additive manufacturing processes. A 5xxx aluminum alloy is an aluminum alloy comprising magnesium (Mg) as the predominate alloying ingredient, except for aluminum. The 5xxx aluminum alloy compositions include the 5xx alloy compositions of the Pink Sheets. Also, as used herein, the term “5xxx aluminum alloy” only refers to the composition and not any associated processing, i.e., as used herein a 5xxx aluminum alloy product does not need to be a wrought product to be considered a 5xxx aluminum alloy composition/product described herein,

In one embodiment, a multiple-metal particle consists of a composition falling within the scope of a 6xxx aluminum alloy, as defined in the Teal Sheets, optionally comprising tolerable levels of oxygen (e.g., from about 0.01 to 0.20 wt. % O) therein due to normal additive manufacturing processes. A 6xxx aluminum alloy is an aluminum alloy comprising both silicon and magnesium, and in amounts sufficient to form the precipitate Mg₂Si. Also, as used herein, the term “6xxx aluminum alloy” only refers to the composition and not any associated processing, i.e., as used herein a 6xxx aluminum alloy product does not need to be a wrought product to be considered a 6xxx aluminum alloy composition/product described herein,

In one embodiment, a multiple-metal particle consists of a composition falling within the scope of a 7xxx aluminum alloy, as defined in the Teal Sheets, optionally comprising tolerable levels of oxygen (e.g., from about 0.01 to 0.20 wt. % O) therein due to normal additive manufacturing processes. A 7xxx aluminum alloy is an aluminum alloy comprising zinc (Zn) as the predominate alloying ingredient, except for aluminum. The 7xxx aluminum alloy compositions include the 7xx alloy compositions of the Pink Sheets. Also, as used herein, the term “7xxx aluminum alloy” only refers to the composition and not any associated processing, i.e., as used herein a 7xxx aluminum alloy product does not need to be a wrought product to be considered a 7xxx aluminum alloy composition/product described herein,

In one embodiment, a multiple-metal particle consists of a composition falling within the scope of a 8xxx aluminum alloy, as defined in the Teal Sheets, optionally comprising tolerable levels of oxygen (e.g., from about 0.01 to 0.20 wt. % O) therein due to normal additive manufacturing processes. A 8xxx aluminum alloy is any aluminum alloy that is not a 1xxx-7xxx aluminum alloy. Examples of 8xxx aluminum alloys include alloys having iron or lithium as the predominate alloying element, other than aluminum. The 8xxx aluminum alloy compositions include the 8xx alloy compositions and the 9xx alloy compositions of the Pink Sheets. As noted in ANSI H35.1 (2009), referenced by the Pink Sheets, the 9xx alloy compositions are aluminum alloys with “other elements” other than copper, silicon, magnesium, zinc, and tin, as the major alloying element. Also, as used herein, the term “8xxx aluminum alloy” only refers to the composition and not any associated processing, i.e., as used herein an 8xxx aluminum alloy product does not need to be a wrought product to be considered an 8xxx aluminum alloy composition/product described herein,

In one embodiment, at least some of the metal particles of the metal powder are metal-nonmetal (M-NM) particles. Metal-nonmetal (M-NM) particles include at least one metal with at least one non-metal. Examples of non-metal elements include oxygen, carbon, nitrogen and boron. Examples of M-NM particles include metal oxide particles (e.g., Al₂O₃), metal carbide particles (e.g., TiC), metal nitride particles (e.g., Si₃N₄), metal borides (e.g., TiB₂), and combinations thereof.

The metal particles and/or the non-metal particles of the metal powder may have tailored physical properties. For example, the particle size, the particle size distribution of the powder, and/or the shape of the particles may be pre-selected. In one embodiment, one or more physical properties of at least some of the particles are tailored in order to control at least one of the density (e.g., bulk density and/or tap density), the flowability of the metal powder, and/or the percent void volume of the metal powder bed (e.g., the percent porosity of the metal powder bed). For example, by adjusting the particle size distribution of the particles, voids in the powder bed may be restricted, thereby decreasing the percent void volume of the powder bed. In turn, aluminum alloy products having an actual density close to the theoretical density may be produced. In this regard, the metal powder may comprise a blend of powders having different size distributions. For example, the metal powder may comprise a blend of a first metal powder having a first particle size distribution and a second metal powder having a second particle size distribution, wherein the first and second particle size distributions are different. The metal powder may further comprise a third metal powder having a third particle size distribution, a fourth metal powder having a fourth particle size distribution, and so on. Thus, size distribution characteristics such as median particle size, average particle size, and standard deviation of particle size, among others, may be tailored via the blending of different metal powders having different particle size distributions. In one embodiment, a final aluminum alloy product realizes a density within 98% of the product's theoretical density. In another embodiment, a final aluminum alloy product realizes a density within 98.5% of the product's theoretical density. In yet another embodiment, a final aluminum alloy product realizes a density within 99.0% of the product's theoretical density. In another embodiment, a final aluminum alloy product realizes a density within 99.5% of the product's theoretical density. In yet another embodiment, a final aluminum alloy product realizes a density within 99.7%, or higher, of the product's theoretical density.

The metal powder may comprise any combination of one-metal particles, multiple-metal particles, M-NM particles and/or non-metal particles to produce the tailored aluminum alloy product, and, optionally, with any pre-selected physical property. For example, the metal powder may comprise a blend of a first type of metal particle with a second type of particle (metal or non-metal), wherein the first type of metal particle is a different type than the second type (compositionally different, physically different or both). The metal powder may further comprise a third type of particle (metal or non-metal), a fourth type of particle (metal or non-metal), and so on. As described in further detail below, the metal powder may be the same metal powder through the additive manufacturing of the aluminum alloy product, or the metal powder may be varied during the additive manufacturing process.

As noted above, additive manufacturing may be used to create, layer-by-layer, an aluminum alloy product. In one embodiment, a metal powder bed is used to create an aluminum alloy product (e.g., a tailored aluminum alloy product). As used herein a “metal powder bed” means a bed comprising a metal powder. During additive manufacturing, particles of different compositions may melt (e.g., rapidly melt) and then solidify (e.g., in the absence of homogenous mixing). Thus, aluminum alloy products having a homogenous or non-homogeneous microstructure may be produced, which aluminum alloy products cannot be achieved via conventional shape casting or wrought product production methods.

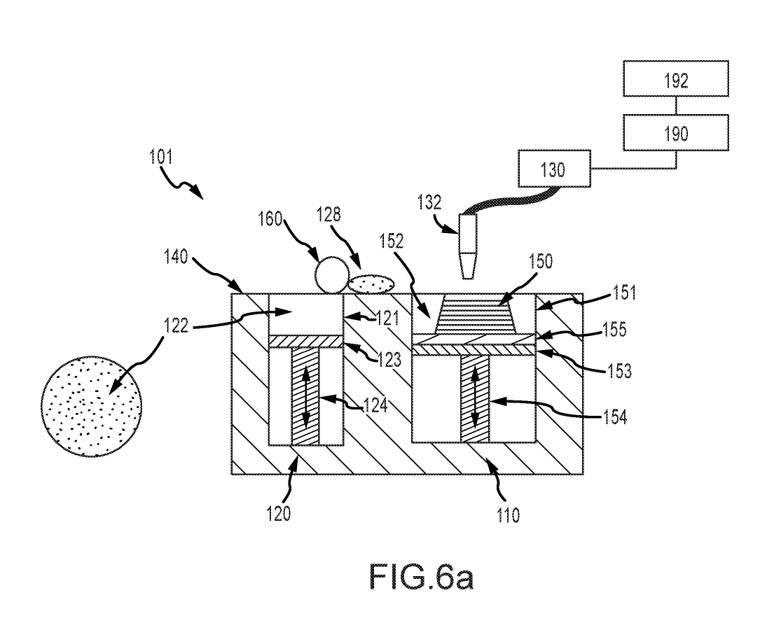

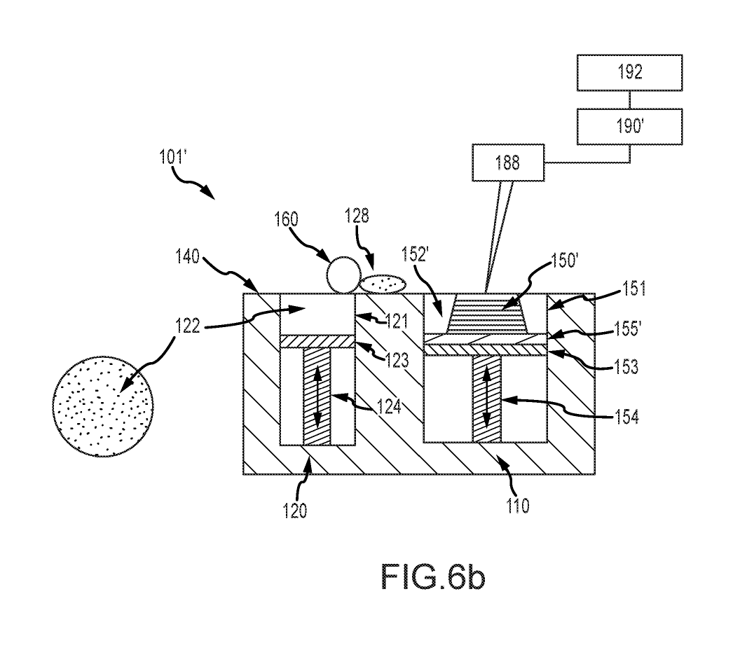

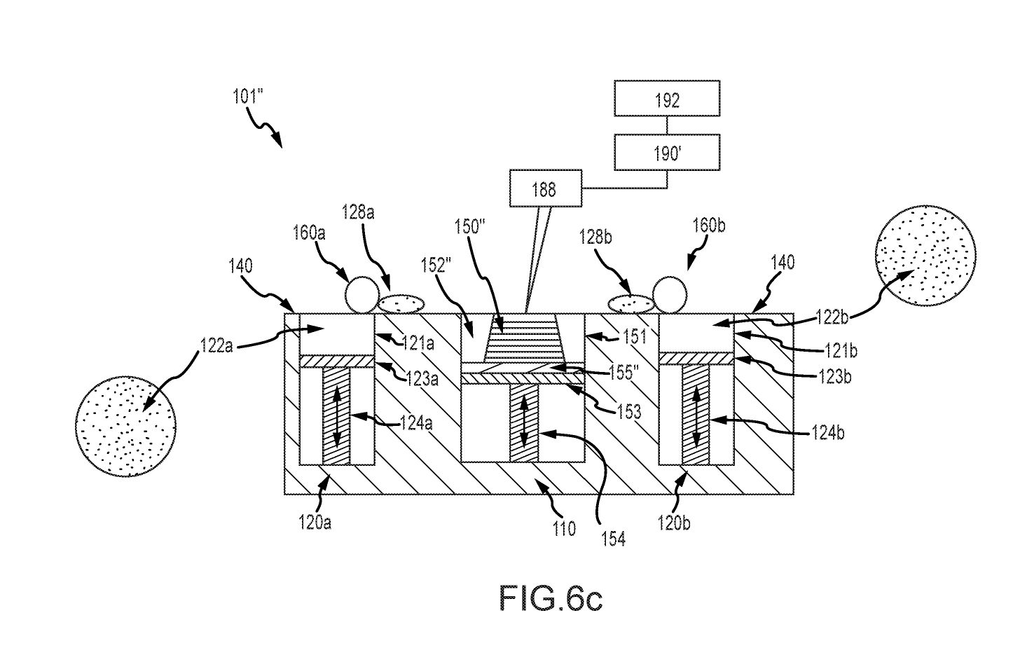

One approach for producing a tailored additively manufactured product using a metal powder bed arrangement is illustrated in FIG. 6a. In the illustrated approach, the system (101) includes a powder bed build space (110), a powder supply (120), and a powder spreader (160). The powder supply (120) includes a powder reservoir (121), a platform (123), and an adjustable device (124) coupled to the platform (123). The adjusting device (124) is adjustable (via a control system, not shown) to move the platform (123) up and down within the powder reservoir (121). The build space (110) includes a build reservoir (151), a build platform (153), and an adjusting device (154) coupled to the build platform (153). The adjusting device (154) is adjustable (via a control system, not shown) to move the build platform (153) up and down within the build reservoir (151), as appropriate, to facilitate receipt of metal powder feedstock (122) from the powder supply (120) and/or production of a tailored 3-D metal part (150).

Powder spreader (160) is connected to a control system (not shown) and is operable to move from the powder reservoir (121) to the build reservoir (151), thereby supplying preselected amount(s) of powder feedstock (122) to the build reservoir (151). In the illustrated embodiment, the powder spreader (160) is a roller and is configured to roll along a distribution surface (140) of the system to gather a preselected volume (128) of powder feedstock (122) and move this preselected volume (128) of powder feedstock (122) to the build reservoir (151) (e.g., by pushing/rolling the powder feedstock). For instance, platform (123) may be moved to the appropriate vertical position, wherein a preselected volume (128) of the powder feedstock (122) lies above the distribution surface (140). Correspondingly, the build platform (153) of the build space (110) may be lowered to accommodate the preselected volume (128) of the powder feedstock (122). As powder spreader (160) moves from an entrance side (the left-hand side in FIG. 6a) to an exit side (the right-hand side of FIG. 6a) of the powder reservoir (121), the powder spreader (160) will gather most or all of the preselected volume (128) of the powder feedstock (122). As powder spreader (160) continues along the distribution surface (140), the gathered volume of powder (128) will be moved to the build reservoir (151) and distributed therein, such as in the form of a layer of metal powder. The powder spreader (160) may move the gathered volume (128) of the metal powder feedstock (122) into the build reservoir (151), or may move the gathered volume (128) onto a surface co-planar with the distribution surface (140), to produce a layer of metal powder feedstock. In some embodiments, the powder spreader (160) may pack/densify the gathered powder (128) within the build reservoir (151). While the powder spreader (160) is shown as being a cylindrical roller, the spreader may be of any appropriate shape, such as rectangular (e.g., when a squeegee is used), or otherwise. In this regard, the powder spreader (160) may roll, push, scrape, or otherwise move the appropriate gathered volume (128) of the metal powder feedstock (122) to the build reservoir (151), depending on its configuration. Further, in other embodiments (not illustrated) a hopper or similar device may be used to provide a powder feedstock to the distribution surface (140) and/or directly to the build reservoir (151).

After the powder spreader (160) has distributed the gathered volume of powder (128) to the build reservoir (151), the powder spreader (160) may then be moved away from the build reservoir (151), such as to a neutral position, or a position upstream (to the left of in FIG. 6a) of the entrance side of the powder reservoir (121). Next, the system (101) uses an adhesive supply (130) and its corresponding adhesive head (132) to selectively provide (e.g., spray) adhesive to the gathered volume of powder (128) contained in the build reservoir (151). Specifically, the adhesive supply (130) is electrically connected to a computer system (192) having a 3-D computer model of a 3-D aluminum alloy part, and a controller (190). After the gathered volume (128) of the powder has been provided to the build reservoir (151), the controller (190) of the adhesive supply (130) moves the adhesive head (132) in the appropriate X-Y directions, spraying adhesive onto the powder volume in accordance with the 3-D computer model of the computer (192).

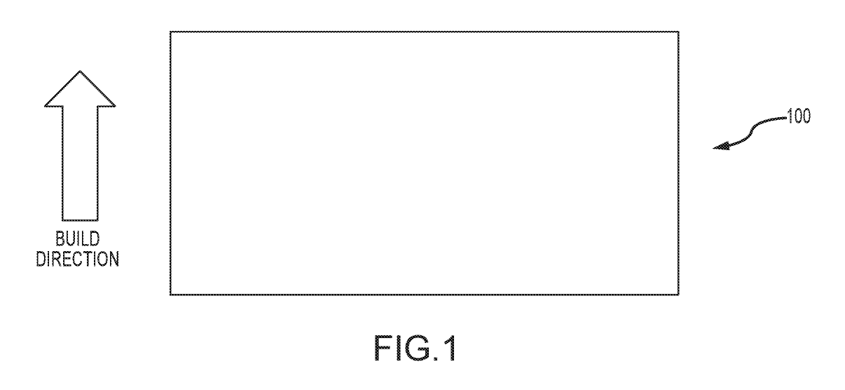

Upon conclusion of the adhesive spraying step, the build platform (153) may be lowered, the powder supply platform (123) may be raised, and the process repeated, with multiple gathered volumes (128) being serially provided to the build reservoir (151) via powder spreader (160), until a multi-layer, tailored 3-D aluminum alloy part (150) is completed. As needed, a heater (not illustrated) may be used between one or more spray operations to cure (e.g., partially cure) any powder sprayed with adhesive. The final tailored 3-D aluminum alloy part (150) may then be removed from the build space (110), wherein excess powder (152) (not having being substantively sprayed by the adhesive) is removed, leaving only the final “green” tailored 3-D aluminum alloy part (150). The final green tailored 3-D aluminum alloy part (150) may then be heated in a furnace or other suitable heating apparatus, thereby sintering the part and/or removing volatile component(s) (e.g., from the adhesive supply) from the part. In one embodiment, the final tailored 3-D aluminum alloy part (150) comprises a homogenous or near homogenous distribution of the metal powder feedstock (e.g., as shown in FIG. 1). Optionally, a build substrate (155) may be used to build the final tailored 3-D aluminum alloy part (150), and this build substrate (155) may be incorporated into the final tailored 3-D aluminum alloy part (150), or the build substrate may be excluded from the final tailored 3-D aluminum alloy part (150). The build substrate (155) itself may be a metal or metallic product (different or the same as the 3-D aluminum alloy part), or may be another material (e.g., a plastic or a ceramic).

As described above, the powder spreader (160) may move the gathered volume (128) of metal powder feedstock (122) to the build reservoir (151) via distribution surface (140). In another embodiment, at least one of the build space (110) and the powder supply (120) are operable to move in the lateral direction (e.g., in the X-direction) such that one or more outer surfaces of the build space (110) and powder supply (120) are in contact. In turn, powder spreader (160) may move the preselected volume (128) of the metal powder feedstock (122) to the build reservoir (151) directly and in the absence of any intervening surfaces between the build reservoir (151) and the powder reservoir (121).

As noted, the powder supply (120) includes an adjustable device (124) which is adjustable (via a control system, not shown) to move the platform (123) up and down within the powder reservoir (151). In one embodiment, the adjustable device (124) is in the form of a screw or other suitable mechanical apparatus. In another embodiment, the adjustable device (124) is a hydraulic device. Likewise, the adjustable device (154) of the build space may be a mechanical apparatus (e.g., a screw) or a hydraulic device.

As noted above, the powder reservoir (121) includes a metal powder feedstock (122), wherein at least some aluminum is present. This powder feedstock (122) may include one-metal particles, multiple-metal particles, M-NM particles, non-metal particles, and combinations thereof, wherein at least one of the one-metal particles, multiple-metal particles, and/or M-NM particles is present. Thus, tailored 3-D aluminum alloy products may be produced.

In one embodiment, the powder feedstock (122) includes a sufficient amount of the one-metal particles, multiple-metal particles, M-NM particles, non-metal particles, and combinations thereof to make a 1xxx aluminum alloy. In another embodiment, the powder feedstock (122) includes a sufficient amount of the one-metal particles, multiple-metal particles, M-NM particles, non-metal particles, and combinations thereof to make a 2xxx aluminum alloy. In yet another embodiment, the powder feedstock (122) includes a sufficient amount of the one-metal particles, multiple-metal particles, M-NM particles, non-metal particles, and combinations thereof to make a 3xxx aluminum alloy. In another embodiment, the powder feedstock (122) includes a sufficient amount of the one-metal particles, multiple-metal particles, M-NM particles, non-metal particles, and combinations thereof to make a 4xxx aluminum alloy. In yet another embodiment, the powder feedstock (122) includes a sufficient amount of the one-metal particles, multiple-metal particles, M-NM particles, non-metal particles, and combinations thereof to make a 5xxx aluminum alloy. In another embodiment, the powder feedstock (122) includes a sufficient amount of the one-metal particles, multiple-metal particles, M-NM particles, non-metal particles, and combinations thereof to make a 6xxx aluminum alloy. In yet another embodiment, the powder feedstock (122) includes a sufficient amount of the one-metal particles, multiple-metal particles, M-NM particles, non-metal particles, and combinations thereof to make a 7xxx aluminum alloy. In another embodiment, the powder feedstock (122) includes a sufficient amount of the one-metal particles, multiple-metal particles, M-NM particles, non-metal particles, and combinations thereof to make a 8xxx aluminum alloy.

In one approach, the powder feedstock (122) includes a sufficient amount of the one-metal particles, multiple-metal particles, M-NM particles, non-metal particles, and combinations thereof to make a dispersion-strengthened aluminum alloy. In one embodiment, the dispersion-strengthened aluminum alloy is one of a 1xxx-8xxx aluminum alloy. In one embodiment, the dispersion-strengthened aluminum alloy is an oxide dispersion strengthened aluminum alloy (e.g., containing a sufficient amount of oxides to dispersion strengthen the aluminum alloy product, but generally not greater than 10 wt. % oxides). In this regard, the metal powder feedstock (122) may include M-O particles, where M is a metal and O is oxygen. Suitable M-O particles include Y₂O₃, Al₂O₃, TiO₂, and La₂O₃, among others.

FIG. 6b utilizes generally the same configuration as FIG. 6a, but uses a laser system (188) (or an electron beam) in lieu of an adhesive system to produce a 3-D aluminum alloy product (150′). All the embodiments and descriptions of FIG. 6a, therefore, apply to the embodiment of FIG. 6b, with the exception of the adhesive supply (130). Instead, a laser (188) is electrically connected to the computer system (192) having a 3-D computer model of a 3-D aluminum alloy part, and a suitable controller (190′). After a gathered volume (128) of the powder has been provided to the build reservoir (151), the controller (190′) of the laser (188) moves the laser (188) in the appropriate X-Y directions, heating selective portions of the powder volume in accordance with the 3-D computer model of the computer (192). In doing so, the laser (188) may heat a portion of the powder to a temperature above the liquidus temperature of the product to be formed, thereby forming a molten pool. The laser may be subsequently moved and/or powered off (e.g., via controller 190′), thereby cooling the molten pool at a cooling rate of at least 1,000° C. per second, thereby forming a portion of the final tailored 3-D aluminum alloy part (150′). In one embodiment, the cooling rate is at least 10,000° C. per second. In another embodiment, the cooling rate is at least 100,000° C. per second. In another embodiment, the cooling rate is at least 1,000,000° C. per second. Upon conclusion of the lasing process, the build platform (153) may be lowered, and the process repeated until the multi-layer, tailored 3-D aluminum alloy part (150′) is completed. As described above, the final tailored 3-D aluminum alloy part may then be removed from the build space (110), wherein excess powder (152′) (not having being substantively lased) is removed. When an electron beam is used as the laser (188), the cooling rates may be at least 10° C. per second (inherently or via controlled cooling), thereby forming a portion of the final tailored 3-D aluminum alloy part (150′).

In one embodiment, the build space (110), includes a heating apparatus (not shown), which may intentionally heat one or more portions of the build reservoir (151) of the build space (110), or powders or lased objects contained therein. In one embodiment, the heating apparatus heats a bottom portion of the build reservoir (151). In another embodiment, the heating apparatus heats one or more side portions of the build reservoir (151). In another embodiment, the heating apparatus heats at least portions of the bottom and sides of the build reservoir (151). The heating apparatus may be useful, for instance, to control the cooling rate and/or relax residual stress(es) during cooling of the lased 3-D aluminum alloy part (150′). Thus, higher yields may be realized for some aluminum alloy products. In one embodiment, controlled heating and cooling are used to produce controlled local thermal gradients within one or more portions of the lased 3-D aluminum alloy part (150′). The controlled local thermal gradients may facilitate, for instance, tailored textures within the final lased 3-D aluminum alloy part (150′). The system of FIG. 6b can use any of the metal powder feedstocks described herein. Further, a build substrate (155′) may be used to build the final tailored 3-D aluminum alloy part (150′), and this build substrate (155′) may be incorporated into the final tailored 3-D aluminum alloy part (150′), or the build substrate may be excluded from the final tailored 3-D aluminum alloy part (150′). The build substrate (155′) itself may be a metal or metallic product (different or the same as the 3-D aluminum alloy part), or may be another material (e.g., a plastic or a ceramic).

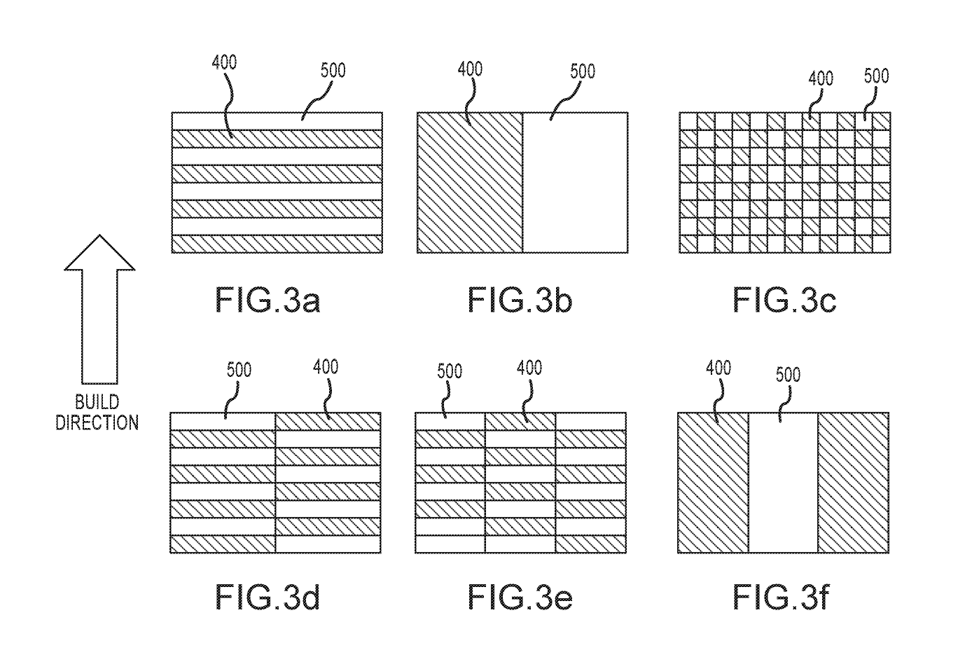

In another approach, and referring now to FIG. 6c, multiple powder supplies (120a, 120b) may be used to feed multiple powder feedstocks (122a, 122b) to the build reservoir (151) to facilitate production of tailored 3-D aluminum alloy products. In the embodiment of FIG. 6c, a first powder spreader (160a) may feed a first powder feedstock (122a) of the first powder supply (120a) to the build reservoir (151), and second powder spreader (160b) may feed a second powder feedstock (122b) of the second powder supply (120b) to the build reservoir (151). The first and second powder feedstocks (122a, 122b) may be provided in any suitable amount and in any suitable order to facilitate production of tailored 3-D aluminum alloy products. As one specific example, a first layer of a 3-D aluminum alloy product may be produced using the first powder feedstock (122a), and as described above relative to FIGS. 6a-6b. A second layer of the 3-D aluminum alloy product may be subsequently produced using the second powder feedstock (122b), and as described above relative to FIGS. 6a-6b. Thus, tailored 3-D aluminum alloy products may be produced. In one embodiment, the second layer overlies the first layer (e.g., as shown in FIG. 3a, showing second portions (500) overlaying first portion (400)). In another embodiment, the first and second layers are separated by other materials (e.g., a third layer of a third material).

As another example, the first powder spreader (160a) may only partially provide the first feedstock (122a) to the build reservoir (151) specifically and intentionally leaving a gap. Subsequently, the second powder spreader (160b) may provide the second feedstock (122b) to the build reservoir (151), at least partially filling the gap. The laser (188) may be utilized at any suitable time(s) relative to these first and second rolling operations. In turn, multi-region 3-D aluminum alloy products may be produced with a first portion (400) being laterally adjacent to the second portion (500) (e.g., as shown in FIG. 3b). Indeed, the system (101″) may operate the build space (110), the powder supplies (120a, 120b) and the powder spreader (160a, 160b), as appropriate, to produce any of the embodiments illustrated in FIGS. 3a-3f.

The first and second powder feedstocks (122a, 122b) may have the same compositions (e.g., for speed/efficiency purposes), but generally have different compositions. In one approach, the first feedstock (122a) comprises a first composition blend and the second feedstock (122b) comprises a second composition blend, different than the first composition. At least one of the first and second powder feedstocks (122a, 122b) include a sufficient amount of aluminum to make an aluminum alloy. Thus, tailored 3-D aluminum alloy parts may be produced. Any combinations of first and second feedstocks (122a, 122b) can be used to produce tailored 3-D aluminum alloy products, such as any of the aluminum alloy products illustrated in FIGS. 1, 2a-2d, and 3a-3f As noted above, the aluminum alloy products may be any of a 1xxx-8xxx aluminum alloy.

As with the approaches of FIGS. 6a-6b, above, while the powder spreaders (160a, 160b) are shown as being cylindrical, the powder spreaders (160a, 160b) may be of any appropriate shape, such as rectangular or otherwise. In this regard, the powder spreaders (160a, 160b) may roll, push, scrape, or otherwise move the feedstocks (122a, 122b) to the build reservoir (151), depending on their configurations. Also, optionally, a build substrate (155″) may be used to build the final tailored 3-D aluminum alloy part (150″), and this build substrate (155″) may be incorporated into the final tailored 3-D aluminum alloy part (150″), or the build substrate may be excluded from the final tailored 3-D aluminum alloy part (150″). The build substrate (155″) itself may be a metal or metallic product (different or the same as the 3-D aluminum alloy part), or may be another material (e.g., a plastic or a ceramic). Although FIG. 6c is illustrated as using a laser (188), the system of FIG. 6c could alternatively use an adhesive system as described above relative to FIG. 6a.

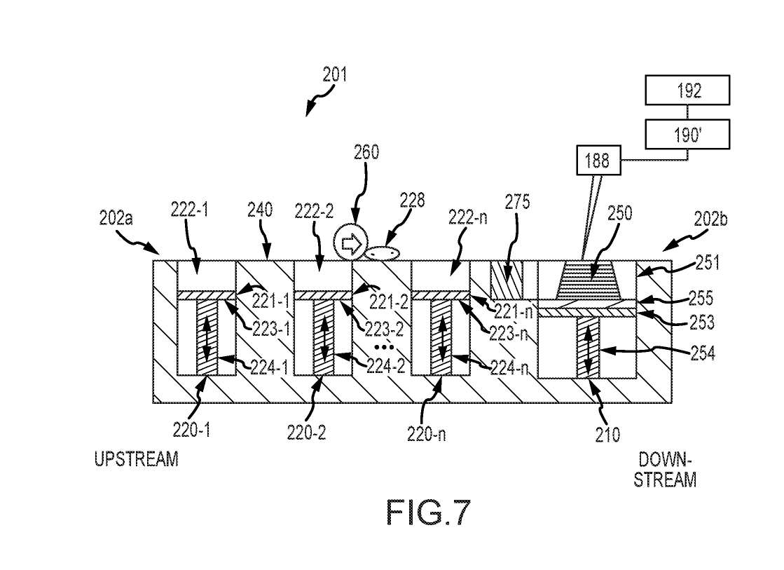

FIG. 7 is a schematic view of a system (201) for making a multi-powder feedstock (222). In the illustrated embodiment, the system (201) is shown as providing a multi-powder feedstock to a powder bed build space (110), such as those described above relative to FIGS. 6a-6c, however, the system (201) could be used to produce multi-component powders for any suitable additive manufacturing method.

The system (201) of FIG. 7 includes a plurality of powder supplies (220-1, 220-2, to 220-n) and a corresponding plurality of powder reservoirs (221-1, 221-2, to 221-n), powder feedstocks (222-1, 222-2, to 222-n), platforms (223-1, 223-2, to 223-n), and adjustment devices (224-1, 224-2, to 224-n), as described above relative to FIGS. 6a-6c. Likewise, build space (210) includes a build reservoir (251), a build platform (253), and an adjustable device (254) coupled to the build platform (253), as described above relative to FIGS. 6a-6c.

A powder spreader (260) may be operable to move between (to and from) a first position (202a) and a second position (202b), the first position being upstream of the first powder supply (220-1), and the second position (202b) being downstream of either the last powder supply (220-n) or the build space (210). As powder spreader (260) moves from the first position (202a) towards the second position (202b), it will gather the appropriate volume of first feedstock (222-1) from the first powder supply (220-1), the appropriate volume of second feedstock (220-2) from the second powder supply (222-2), and so forth, thereby producing a gathered volume (228). The volumes and compositions of the first through final feedstocks (220-1 to 220-n) can be tailored and controlled for each rolling cycle to facilitate production of tailored 3-D aluminum alloy products, or portions thereof.

For instance, the first powder supply (220-1) may include a first metal powder (e.g., a one-metal powder) as its feedstock (222-1), and the second powder supply (220-2) may include a second metal powder (e.g., a multi-metal powder) as its feedstock (222-2). As powder spreader (160) moves from upstream of the first powder supply (220-1), along upper surface (240), to downstream of the second powder supply (220-2), the powder spreader (260) may gather the first and second volumes of metal powders (222-1, 222-2), thereby producing a tailored powder blend (228) downstream of the second powder supply (220-2). As powder spreader (160) moves towards build reservoir (151), the first and second powders may mix (e.g., by tumbling, by applying vibration to upper surface (240), e.g., via optional vibratory apparatus (275) or by other mixing/stirring means). Subsequent powder feedstocks (222-3 (not shown) to 222-n) may be utilized or avoided (e.g., by closing the top of the powder supply(ies)) as powder spreader (160) moves towards the second position (202b). Ultimately, a final powder feedstock (222_{1+2+ . . . n}) may be provided for additive manufacturing, such as for use in powder bed build space (210). A laser (188) may then be used, as described above relative to FIG. 6b, to produce a portion of the final tailored 3-D aluminum alloy part (250).

The flexibility of the system (201) facilitates the in-situ production of any of the products illustrated in FIGS. 1, 2a-2d, and 3a-3f, among others. Any suitable powders having any suitable composition, and any suitable particle size distributions may be used as the feedstocks (222-1 to 222-n) of the system (201). For instance, to produce a homogenous 3-D aluminum alloy product, such as that illustrated in FIG. 1, generally the same volumes and compositions for each rolling cycle may be utilized. To produced multi-region products, such as those illustrated in FIGS. 3a-3f, the powder spreader (260) may gather different volume(s) of feedstocks from the same or different powder supplies, as appropriate. As one example, to produce the layered product of FIG. 3a, a first rolling cycle may gather a first volume of feedstock (222-1) from the first powder supply (220-1), and a second volume of feedstock (222-2) from the second powder supply (220-2). For a subsequent cycle, and to produce a second, different layer, the height of the first powder supply (220-1) may be adjusted (via its platform) to provide a different volume of the first feedstock (222-1) (the height of the second powder supply (220-2) may remain the same or may also change). In turn, a different powder blend will be produced due to the different volume of the first feedstock utilized in the subsequent cycle, thereby producing a different layer of material.

As an alternative, the system (201) may be controlled such that powder spreader (260) only gathers materials from the appropriate powder supplies (220-2 to 220-n) to produce the desired material layers. For instance, the powder spreader (260) may be controlled to avoid the appropriate powder supplies (e.g., moving non-linearly to avoid). As another example, the powder supplies (220-1 to 220-n) may include selectively operable lids or closures, such that the system (201) can remove any appropriate powder supplies (220-1 to 220-n) from communicating with the powder spreader (260) for any appropriate cycle by selectively closing such lids or closures.

The powder spreader (260) may be controlled via a suitable control system to move from the first position (202a) to the second position (202b), or any positions therebetween. For instance, after a cycle, the powder spreader (260) may return to a position downstream of the first powder supply (220-1), and upstream of the second powder supply (220-2) to facilitate gathering of the appropriate volume of the second feedstock (222-2), avoiding the first feedstock (222-1) altogether. Further, the powder spreader (160) may be moved in a linear or non-linear fashion, as appropriate to gather the appropriate amounts of the feedstocks (222-1 to 222-n) for the additive manufacturing operation. Also, multiple rollers can be used to move and/or blend the feedstocks (222-1 to 222-n). Finally, while more than two powder supplies (222-1 to 222-n) are illustrated in FIG. 7, two powder supplies (222-1 to 222-2) may be useful as well.

The additive manufacturing apparatus and systems described in FIGS. 6a-6c and 7 may be used to make any suitable aluminum-based 3-D product. An aluminum-based product includes aluminum as the majority component. In one embodiment, the same general powder is used throughout the additive manufacturing process to produce an aluminum alloy product. For instance, and referring now to FIG. 1, the final tailored aluminum alloy product (100) may comprise a single region produced by using generally the same metal powder during the additive manufacturing process. In one embodiment, the metal powder consists of one-metal particles. In one embodiment, the metal powder consists of a mixture of one-metal particles and multiple-metal particles. In one embodiment, the metal powder consists of one-metal particles and M-NM particles. In one embodiment, the metal powder consists of one-metal particles, multiple-metal particles and M-NM particles. In one embodiment, the metal powder consists of multiple-metal particles. In one embodiment, the metal powder consists of multiple-metal particles and M-NM particles. In one embodiment, the metal powder consists of M-NM particles. In any of these embodiments, non-metal particles may be optionally used in the metal powder. In any of these embodiments, multiple different types of the one-metal particles, the multiple-metal particles, the M-NM particles, and/or the non-metal particles may be used to produce the metal powder. For instance, a metal powder consisting of one-metal particles may include multiple different types of one-metal particles. As another example, a metal powder consisting of multiple-metal particles may include multiple different types of multiple-metal particles. As another example, a metal powder consisting of one-metal and multiple metal particles may include multiple different types of one-metal and/or multiple metal particles. Similar principles apply to M-NM and non-metal particles.

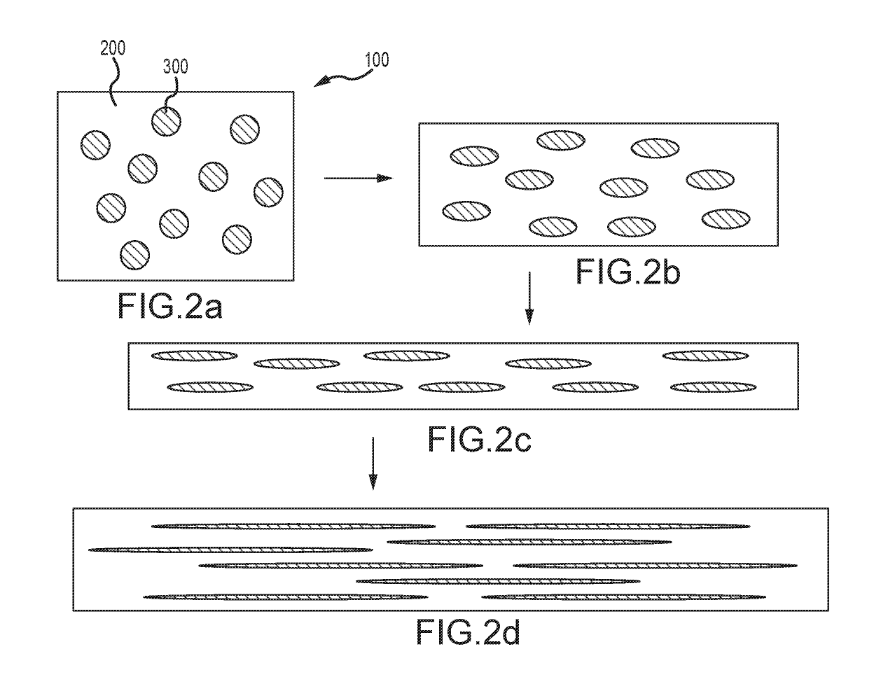

As one specific example, and with reference now to FIGS. 2a-2d, the single metal powder may include a blend of (1) at least one of (a) M-NM particles and (b) non-metal particles (e.g., BN particles) and (2) at least one of (a) one-metal particles or (b) multiple-metal particles. The single powder blend may be used to produce an aluminum alloy body having a large volume of a first region (200) and smaller volume of a second region (300). For instance, the first region (200) may comprise an aluminum alloy region (e.g., due to the one-metal particles and/or multiple metal particles), and the second region (300) may comprise an M-NM region (e.g., due to the M-NM particles and/or the non-metal particles). After or during production, an additively manufactured product comprising the first region (200) and the second region (300) may be deformed (e.g., by one or more of rolling, extruding, forging, stretching, compressing), as illustrated in FIGS. 2b-2d. The final deformed product may realize, for instance, higher strength due to the interface between the first region (200) and the M-NM second region (300), which may restrict planar slip.

The final tailored aluminum alloy product may alternatively comprise at least two separately produced distinct regions. In one embodiment, different metal powder bed types may be used to produce a final tailored 3-D aluminum alloy product. For instance, a first metal powder bed may comprise a first metal powder and a second metal powder bed may comprise a second metal powder, different than the first metal powder (e.g., as illustrated in FIGS. 6c and 7). The first metal powder bed may be used to produce a first layer or portion of an aluminum alloy product, and the second metal powder bed may be used to produce a second layer or portion of the aluminum alloy product. For instance, and with reference now to FIGS. 3a-3f, a first region (400) and a second region (500), may be present. To produce the first region (400), a first portion (e.g., a layer) of a metal powder bed may comprise a first metal powder. To produce the second region (500), a second portion (e.g., a layer) of metal powder may comprise a second metal powder, different than the first layer (compositionally and/or physically different). Third distinct regions, fourth distinct regions, and so on can be produced using additional metal powders and layers. Thus, the overall composition and/or physical properties of the metal powder during the additive manufacturing process may be pre-selected, resulting in tailored aluminum alloy products having tailored compositions and/or microstructures.

In one aspect, the first metal powder consists of one-metal particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body (e.g., as per FIG. 6c or FIG. 7), or may be blended with the first metal powder prior to being provided to the build reservoir (e.g., as per FIG. 7). In one embodiment, the second metal powder consists of another type of one-metal particles. In another embodiment, the second metal powder consists of one-metal particles and multiple-metal particles. In yet another embodiment, the second metal powder consists of one-metal particles and M-NM particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of multiple-metal particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body (e.g., as per FIG. 6c or FIG. 7), or may be blended with the first metal powder prior to being provided to the build reservoir (e.g., as per FIG. 7). In one embodiment, the second metal powder consists of another type of multiple-metal particles. In another embodiment, the second metal powder consists of one-metal particles. In yet another embodiment, the second metal powder consists of a mixture of one-metal particles and multiple-metal particles. In another embodiment, the second metal powder consists of a mixture of one-metal particles and M-NM particles. In yet another embodiment, the second metal powder consists of one-metal particles, multiple-metal particles and M-NM particles. In another embodiment, the second metal powder consists of a mixture of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of M-NM particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body (e.g., as per FIG. 6c or FIG. 7), or may be blended with the first metal powder prior to being provided to the build reservoir (e.g., as per FIG. 7). In one embodiment, the second metal powder consists of another type of M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of one-metal particles, multiple-metal particles and M-NM particles. In another embodiment, the second metal powder consists of multiple-metal particles. In another embodiment, the second metal powder consists of multiple-metal particles and M-NM particles. In any of these embodiments, non-metal particles may be optionally used in the second metal powder to produce the second region.

In another aspect, the first metal powder consists of a mixture of one-metal particles and multiple-metal particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body (e.g., as per FIG. 6c or FIG. 7), or may be blended with the first metal powder prior to being provided to the build reservoir (e.g., as per FIG. 7). In one embodiment, the second metal powder consists of another mixture of one-metal particles and multiple metal particles. In another embodiment, the second metal powder consists of one-metal particles. In yet another embodiment, the second metal powder consists of one-metal particles and M-NM particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of one-metal particles and M-NM particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body (e.g., as per FIG. 6c or FIG. 7), or may be blended with the first metal powder prior to being provided to the build reservoir (e.g., as per FIG. 7). In one embodiment, the second metal powder consists of another mixture of one-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of one-metal particles, multiple-metal particles and M-NM particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body (e.g., as per FIG. 6c or FIG. 7), or may be blended with the first metal powder prior to being provided to the build reservoir (e.g., as per FIG. 7). In one embodiment, the second metal powder consists of another mixture of one-metal particles, multiple-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of multiple-metal particles and M-NM particles. The first metal powder may be used in a first metal powder bed layer to produce a first region (400) of a tailored aluminum alloy body. Subsequently, a second metal powder may be used as a second metal powder bed layer to produce a second region (500) of a tailored aluminum alloy body (e.g., as per FIG. 6c or FIG. 7), or may be blended with the first metal powder prior to being provided to the build reservoir (e.g., as per FIG. 7). In one embodiment, the second metal powder consists of another mixture of multiple-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of multiple-metal particles. In another embodiment, the second metal powder consists of one-metal particles, multiple-metal particles and M-NM particles. In yet another embodiment, the second metal powder consists of M-NM particles. In any of these embodiments, non-metal particles may be optionally used in the second metal powder to produce the second region.

Thus, the systems and apparatus of FIGS. 6a-6c and 7 may be useful in producing a variety of additively manufactured 3-D aluminum-based products, such as any of the single or multi-region products illustrated in FIGS. 1, 2a-2d, and 3a-3f, such as when at least a first region of the additively manufactured 3-D metal products is aluminum-based, or when the first region comprises any one of a 1xxx-8xxx, aluminum alloy, as defined above. In one embodiment, a 3-D aluminum-based product includes at least 35 wt. % Al (based on the entire content of the final 3-D product), wherein aluminum is the majority component. In another embodiment, a 3-D aluminum-based product includes at least 40 wt. % Al, wherein aluminum is the majority component. In another embodiment, a 3-D aluminum-based product includes at least 45 wt. % Al, wherein aluminum is the majority component. In another embodiment, a 3-D aluminum-based product includes at least 49 wt. % Al, wherein aluminum is the majority component. In another embodiment, a 3-D aluminum-based product includes at least 50.1 wt. % Al.

The powders used to in the additive manufacturing processes described herein may be produced by atomizing a material (e.g., an ingot) of the appropriate material into powders of the appropriate dimensions relative to the additive manufacturing process to be used.

After or during production, an additively manufactured product may be deformed (e.g., by one or more of rolling, extruding, forging, stretching, compressing). The final deformed product may realize, for instance, improved properties due to the tailored regions of the aluminum alloy product.

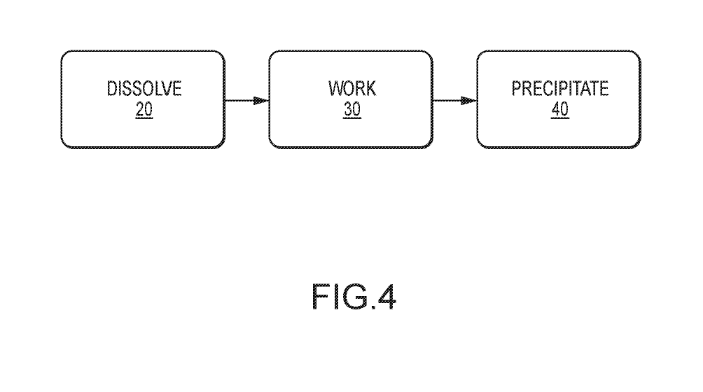

Referring now to FIG. 4, the additively manufactured product may be subject to any appropriate dissolving (20), working (30) and/or precipitation hardening steps (40). If employed, the dissolving (20) and/or the working (30) steps may be conducted on an intermediate form of the additively manufactured body and/or may be conducted on a final form of the additively manufactured body. If employed, the precipitation hardening step (40) is generally conducted relative to the final form of the additively manufactured body.

With continued reference to FIG. 4, the method may include one or more dissolving steps (20), where an intermediate product form and/or the final product form are heated above a solvus temperature of the product but below the solidus temperature of the material, thereby dissolving at least some of the undissolved particles. The dissolving step (20) may include soaking the material for a time sufficient to dissolve the applicable particles. In one embodiment, a dissolving step (20) may be considered a homogenization step. After the soak, the material may be cooled to ambient temperature for subsequent working. Alternatively, after the soak, the material may be immediately hot worked via the working step (30).

The working step (30) generally involves hot working and/or cold working an intermediate product form. The hot working and/or cold working may include rolling, extrusion or forging of the material, for instance. The working (30) may occur before and/or after any dissolving step (20). For instance, after the conclusion of a dissolving step (20), the material may be allowed to cool to ambient temperature, and then reheated to an appropriate temperature for hot working. Alternatively, the material may be cold worked at around ambient temperatures. In some embodiments, the material may be hot worked, cooled to ambient, and then cold worked. In yet other embodiments, the hot working may commence after a soak of a dissolving step (20) so that reheating of the product is not required for hot working.

The working step (30) may result in precipitation of second phase particles. In this regard, any number of post-working dissolving steps (20) can be utilized, as appropriate, to dissolve at least some of the undissolved second phase particles that may have formed due to the working step (30).

After any appropriate dissolving (20) and working (30) steps, the final product form may be precipitation hardened (40). The precipitation hardening (40) may include heating the final product form above a solvus temperature for a time sufficient to dissolve at least some particles precipitated due to the working, and then rapidly cooling the final product form. The precipitation hardening (40) may further include subjecting the product to a target temperature for a time sufficient to form precipitates (e.g., strengthening precipitates), and then cooling the product to ambient temperature, thereby realizing a final aged product having desired precipitates therein. As may be appreciated, at least some working (30) of the product may be completed after a precipitating (40) step. In one embodiment, a final aged product contains ≥0.5 vol. % of the desired precipitates (e.g., strengthening precipitates) and ≤0.5 vol. % of coarse second phase particles.

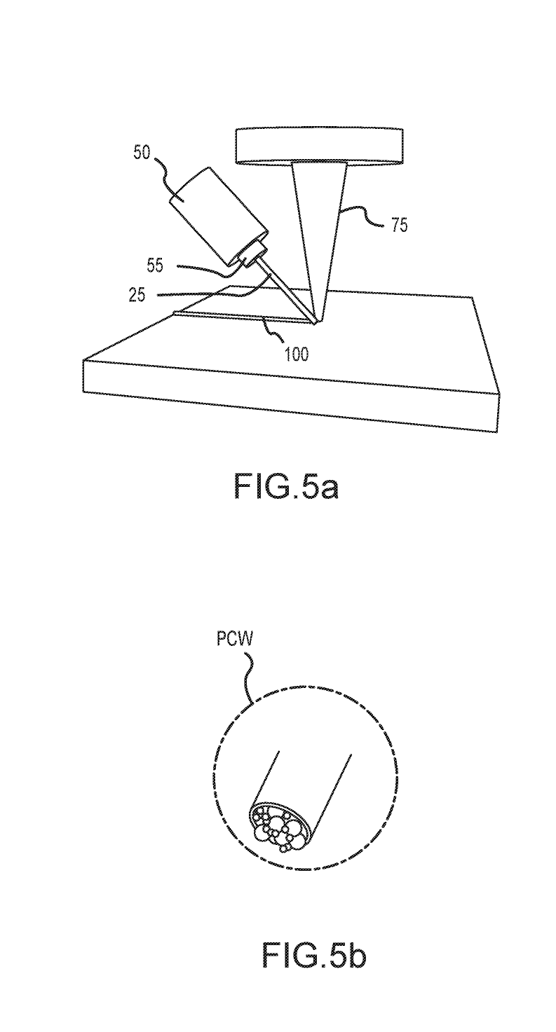

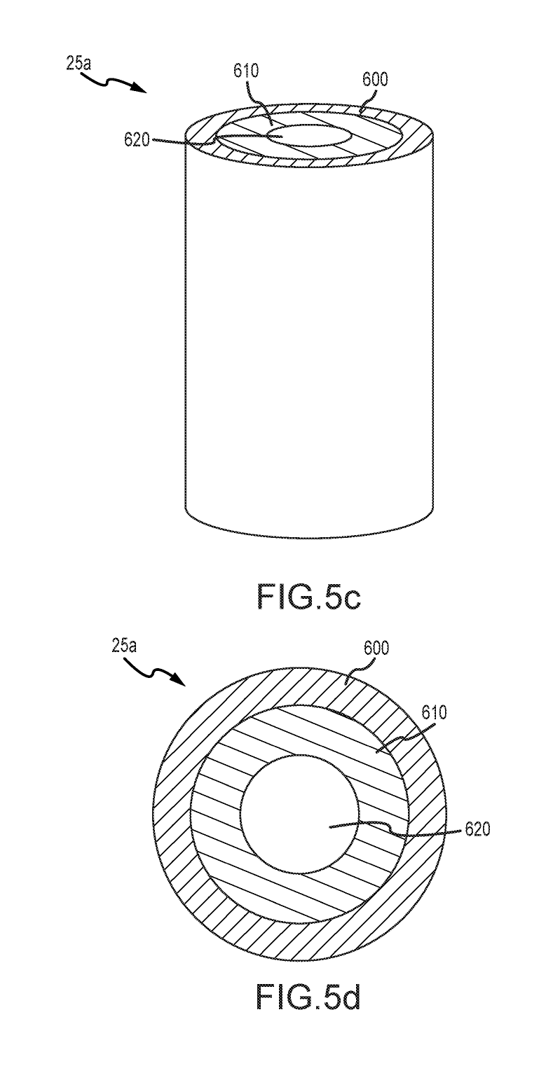

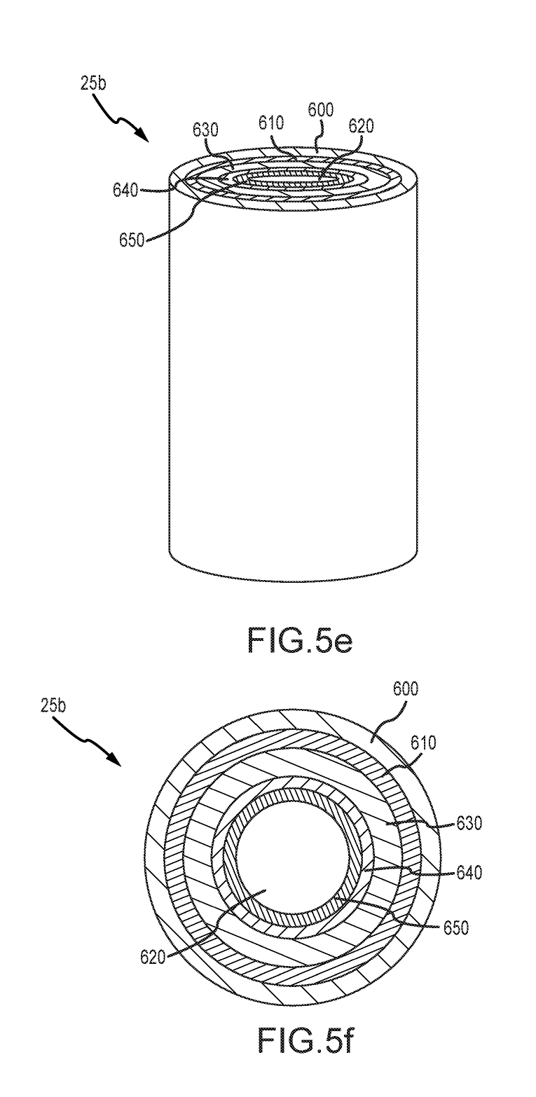

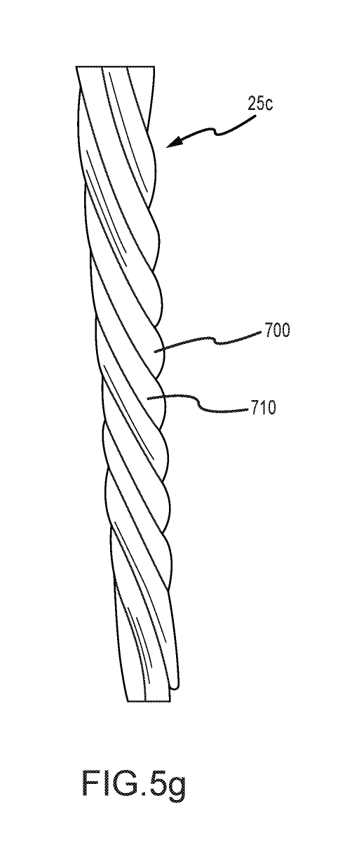

In one approach, electron beam (EB) or plasma arc techniques are utilized to produce at least a portion of the additively manufactured aluminum alloy body. Electron beam techniques may facilitate production of larger parts than readily produced via laser additive manufacturing techniques. For instance, and with reference now to FIG. 5a, in one embodiment, a method comprises feeding a small diameter wire (25) (e.g., ≥2.54 mm in diameter) to the wire feeder portion (55) of an electron beam gun (50). The wire (25) may be of the compositions, described above, provided it is a drawable composition (e.g., when produced per the process conditions of U.S. Pat. No. 5,286,577), or the wire is producible via powder conform extrusion, for instance (e.g., as per U.S. Pat. No. 5,284,428). The electron beam (75) heats the wire or tube, as the case may be, above the liquidus point of the body to be formed, followed by rapid solidification of the molten pool to form the deposited material (100).

In one embodiment, and referring now to FIG. 5b, the wire (25) is a powder cored wire (PCW), where a tube portion of the wire contains a volume of the particles therein, such as any of the particles described above (one-metal particles, multiple metal particles, metal-nonmetal particles, non-metal particles, and combinations thereof), while the tube itself may comprise aluminum or an aluminum alloy (e.g., a suitable 1xxx-8xxx aluminum alloy). The composition of the volume of particles within the tube may be adapted to account for the amount of aluminum in the tube so as to realize the appropriate end composition.

In one embodiment, the tube is a high purity aluminum or a 1xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 1xxx aluminum alloy and the particles comprise one-metal particles. In one embodiment, the tube is a high purity aluminum or a 1xxx aluminum alloy and the particles comprise multiple metal particles. In one embodiment, the tube is a high purity aluminum or a 1xxx aluminum alloy and the particles comprise metal-nonmetal particles. In one embodiment, the tube is a high purity aluminum or a 1xxx aluminum alloy and the particles comprise non-metal particles. In one embodiment, the tube is a high purity aluminum or a 1xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 1xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 1xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 2xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 2xxx aluminum alloy and the particles comprise one-metal particles. In one embodiment, the tube is a high purity aluminum or a 2xxx aluminum alloy and the particles comprise multiple metal particles. In one embodiment, the tube is a high purity aluminum or a 2xxx aluminum alloy and the particles comprise metal-nonmetal particles. In one embodiment, the tube is a high purity aluminum or a 2xxx aluminum alloy and the particles comprise non-metal particles. In one embodiment, the tube is a high purity aluminum or a 2xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 2xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 2xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 3xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 3xxx aluminum alloy and the particles comprise one-metal particles. In one embodiment, the tube is a high purity aluminum or a 3xxx aluminum alloy and the particles comprise multiple metal particles. In one embodiment, the tube is a high purity aluminum or a 3xxx aluminum alloy and the particles comprise metal-nonmetal particles. In one embodiment, the tube is a high purity aluminum or a 3xxx aluminum alloy and the particles comprise non-metal particles. In one embodiment, the tube is a high purity aluminum or a 3xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 3xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 3xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 4xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 4xxx aluminum alloy and the particles comprise one-metal particles. In one embodiment, the tube is a high purity aluminum or a 4xxx aluminum alloy and the particles comprise multiple metal particles. In one embodiment, the tube is a high purity aluminum or a 4xxx aluminum alloy and the particles comprise metal-nonmetal particles. In one embodiment, the tube is a high purity aluminum or a 4xxx aluminum alloy and the particles comprise non-metal particles. In one embodiment, the tube is a high purity aluminum or a 4xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 4xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 4xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 5xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 5xxx aluminum alloy and the particles comprise one-metal particles. In one embodiment, the tube is a high purity aluminum or a 5xxx aluminum alloy and the particles comprise multiple metal particles. In one embodiment, the tube is a high purity aluminum or a 5xxx aluminum alloy and the particles comprise metal-nonmetal particles. In one embodiment, the tube is a high purity aluminum or a 5xxx aluminum alloy and the particles comprise non-metal particles. In one embodiment, the tube is a high purity aluminum or a 5xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 5xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 5xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 6xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 6xxx aluminum alloy and the particles comprise one-metal particles. In one embodiment, the tube is a high purity aluminum or a 6xxx aluminum alloy and the particles comprise multiple metal particles. In one embodiment, the tube is a high purity aluminum or a 6xxx aluminum alloy and the particles comprise metal-nonmetal particles. In one embodiment, the tube is a high purity aluminum or a 6xxx aluminum alloy and the particles comprise non-metal particles. In one embodiment, the tube is a high purity aluminum or a 6xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 6xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 6xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 7xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 7xxx aluminum alloy and the particles comprise one-metal particles. In one embodiment, the tube is a high purity aluminum or a 7xxx aluminum alloy and the particles comprise multiple metal particles. In one embodiment, the tube is a high purity aluminum or a 7xxx aluminum alloy and the particles comprise metal-nonmetal particles. In one embodiment, the tube is a high purity aluminum or a 7xxx aluminum alloy and the particles comprise non-metal particles. In one embodiment, the tube is a high purity aluminum or a 7xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 7xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 7xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In one embodiment, the tube is a high purity aluminum or a 8xxx aluminum alloy and the particles held within the tube, as shown in FIG. 5b, are selected from the group consisting of one-metal particles, multiple metal particles, metal-nonmetal particles, non-metal particles, and combinations thereof. In one embodiment, the tube is a high purity aluminum or a 8xxx aluminum alloy and the particles comprise one-metal particles. In one embodiment, the tube is a high purity aluminum or a 8xxx aluminum alloy and the particles comprise multiple metal particles. In one embodiment, the tube is a high purity aluminum or a 8xxx aluminum alloy and the particles comprise metal-nonmetal particles. In one embodiment, the tube is a high purity aluminum or a 8xxx aluminum alloy and the particles comprise non-metal particles. In one embodiment, the tube is a high purity aluminum or a 8xxx aluminum alloy and the particles include at least two different types of the types of particles, i.e., the particles include at least two of the (a)-(d) particle types, where (a) is the one-metal particles, (b) is the multiple metal particles, (c) is the metal-nonmetal particles and (d) is the non-metal particles. In one embodiment, the tube is a high purity aluminum or a 8xxx aluminum alloy and the particles include at least three different types of the types of particles, i.e., the particles include at least three of the (a)-(d) particle types, where (a) is the one-metal particles, (b) is the multiple metal particles, (c) is the metal-nonmetal particles and (d) is the non-metal particles. In one embodiment, the tube is a high purity aluminum or a 8xxx aluminum alloy and the particles include at least four different types of the types of particles, i.e., the particles include all of the (a)-(d) particle types, where (a) is the one-metal particles, (b) is the multiple metal particles, (c) is the metal-nonmetal particles and (d) is the non-metal particles.

In another embodiment, and referring now to FIGS. 5c-5d, the wire (25a) is a multiple-tube wire having first elongate outer tube portion (600) and at least a second elongate inner tube portion (610). The first portion (600) comprises a first material, and the second portion (610) comprises a second material, generally different than the first material. The wire (25a) may include a hollow core (620), as shown, or may include a solid core or may include a volume of particles within the core, as described above relative to FIGS. 5a-5b. In any event, the collective compositions of the first material, the second material and any materials of the core are such that, after deposition, an aluminum-based product is produced as a result of the collective compositions of the first material, the second material and any materials of the core. Thus, the first material, the second material, and/or any materials of the core may be aluminum-based, as defined above. In one embodiment, at least one of the first material, the second material, and/or any materials of the core comprise an aluminum alloy, such as any of the 1xxx-8xxx aluminum alloys, defined above. In another embodiment, at least two of the first material, the second material, and/or any materials of the core comprise an aluminum alloy, such as any of the 1xxx-8xxx aluminum alloys, defined above. In another embodiment, all of the first material, the second material, and/or any materials of the core comprise an aluminum alloy, such as any of the 1xxx-8xxx aluminum alloys, defined above. M-O materials may be used in one or both of the first and second wires and/or the core materials when oxides are included in the final product for oxide dispersion strengthening.

The thickness of the first elongate outer tube portion (600) and the at least second elongate inner tube portion (610) may be tailored to provide the appropriate end composition for the metal matrix. Further, as shown in FIGS. 5e-5f, a wire (25b) may include any number of multiple elongate tubes (e.g., tubes 600-610 and 630-650) each of the appropriate composition and thickness to provide the appropriate end composition. As described above relative to FIG. 5c-5d, the core (620) may be a hollow core (620), as shown, or may include a solid core or may include a volume of particles within the core, as described above relative to FIGS. 5a-5b.

In another embodiment, and referring now to FIG. 5g, the wire (25c) is a multiple-fiber wire having a first fiber (700) and at least a second fiber (710) intertwined with the first wire (700). The first fiber (700) comprises a first material, and the second portion (710) comprises a second material, generally different than the first material. The collective compositions of the first material and the second material are such that, after deposition, an aluminum-based product is produced as a result of the collective compositions of the first material and the second material. Thus, the first material and/or the second material may be aluminum-based, as defined above. In one embodiment, at least one of the first material and the second material comprise an aluminum alloy, such as any of the 1xxx-8xxx aluminum alloys, defined above. In one embodiment, both of the first material and the second material comprise an aluminum alloy, such as any of the 1xxx-8xxx aluminum alloys, defined above. M-O materials may be used in one or both of the first and second wires when oxides are included in the final product for oxide dispersion strengthening.

While various embodiments of the new technology described herein have been described in detail, it is apparent that modifications and adaptations of those embodiments will occur to those skilled in the art. However, it is to be expressly understood that such modifications and adaptations are within the spirit and scope of the presently disclosed technology.

What is claimed is:

1. A method for producing an aluminum alloy product, the method comprising:
first gathering a first feedstock from a first powder supply of an additive manufacturing system;
second gathering a second feedstock from a second powder supply of the additive manufacturing system;
wherein at least one of the first feedstock and the second feedstock includes particles having aluminum therein;
combining the first and second feedstocks, thereby producing a metal powder blend having aluminum therein;
providing the metal powder blend to a build space of the additive manufacturing system.

2. The method of claim 1, wherein the first gathering comprises mechanically pushing the first feedstock via a roller, and wherein the second gathering comprises mechanically pushing the second feedstock via the roller.

3. The method of claim 2, comprising:
pushing the first feedstock towards the second feedstock via the roller.

4. The method of claim 3, wherein the providing step comprises:
pushing the metal powder blend from downstream of the second powder supply to the build space.

5. The method of claim 1, wherein the first gathering step comprises:
adjusting a height of a platform of the first powder supply, thereby providing a first volume of the first feedstock for the first gathering step.

6. The method of claim 5, comprising:
after the first gathering step, moving the height of the platform, thereby providing a third feedstock, wherein the third feedstock is a second volume of the first feedstock.

7. The method of claim 6, comprising:
third gathering the third feedstock from the first powder supply;
fourth gathering a second feedstock from the second powder supply; and
combining the third feedstock and the second feedstock.

8. The method of claim 7, wherein the second gathering and the fourth gathering steps gather an equivalent volume of the second feedstock.

9. The method of claim 1, comprising:
producing a tailored 3-D aluminum-based product in the build space of the additive manufacturing system using the metal powder blend.

10. The method of claim 9, wherein the 3-D aluminum-based product is an oxide dispersion strengthened 3-D aluminum alloy product having M-O particles therein, wherein M is a metal and O is oxygen.

11. The method of claim 10, wherein the oxide dispersion strengthened 3-D aluminum alloy product comprises a sufficient amount of the M-O particles to facilitate oxide dispersion strengthening, and wherein the oxide dispersion strengthened 3-D aluminum alloy product comprises not greater than 10 wt. % of the M-O particles.

12. The method of claim 11, wherein the M-O particles are selected from the group consisting of Y₂O₃, Al₂O₃, TiO₂, La₂O₃, and combinations thereof.

13. An additive manufacturing system, comprising:
a first powder supply having a first powder reservoir for distributing a first powder feedstock;
a second powder supply downstream of the first powder supply, wherein the second powder supply has a second powder reservoir for distributing a second powder feedstock;
a powder spreader configured to:
(a) gather the first powder feedstock from the first powder supply;
(b) gather the second powder feedstock from the second powder supply;
(c) move at least from the first powder supply to the second powder supply;
(d) move from at least one of the first and second powder supplies to a build space for building an additive manufacturing product, wherein the build space is downstream of the second powder supply, and wherein the build space comprises a build reservoir for receiving powder feedstock.

14. The additive manufacturing system of claim 13, comprising:
a distribution surface associated with the first powder supply, the second powder supply and the build space;
wherein the powder spreader is configured to move along the distribution surface with at least one of the first and second powder feedstocks.

15. The additive manufacturing system of claim 14, wherein the first powder supply comprises:
a first platform disposed within the first powder reservoir, wherein the first platform is configured to move longitudinally up and down within the first powder reservoir;
wherein the first powder reservoir is configured to contain the first powder feedstock;
wherein the first platform is controllable by a controller to provide a controlled volume of the first powder feedstock relative to the distribution surface.

16. The additive manufacturing system of claim 15, wherein the distribution surface is disposed above the first platform.

17. The additive manufacturing system of claim 16, wherein the powder spreader is configured to move along the distribution surface from the first powder reservoir to the second powder reservoir.

18. The additive manufacturing system of claim 17, wherein the powder spreader is configured to move along the distribution surface from the second powder reservoir to the build reservoir.

19. The additive manufacturing system of claim 17, comprising a vibratory apparatus disposed between the second powder reservoir and the build reservoir.

20. The additive manufacturing system of claim 14, wherein the distribution surface is planar and defines an upper working surface for the powder spreader.
